(19) United States
(12) Patent Application Publication
(10) Pub. No.: US 2002/0140722 A1
(43) Pub. Date: Oct. 3, 2002

(54) Video system character list generator and method

(75) Inventors: Kamala Ayyar, Teaneck, NJ (US); Joseph Curtis, Harriman, NY (US)

Correspondence Address: Alan M. Weisberg, Christopher & Weisberg, P.A., Suite 2040, 200 East Las Olas Boulevard, Fort Lauderdale, FL, 33301, US

(73) Assignee: Pelco

(21) Appl. No.: 10/115,122

(22) Filed: Apr. 2, 2002

Related U.S. Application Data
(60) Provisional application No. 60/280,875, filed on Apr. 2, 2001.

(51) Int. Cl. G09G 5/00

(52) U.S. Cl. 345/723; 345/721; 345/716

(57) ABSTRACT

A video apparatus and method which stores at least one main list of characters. An input device can be used to select characters from the main list and store them in memory as a working list. A central processing unit is electrically coupled to the memory and is configured to activate a selected working list, display the working list on a display monitor, and store selected characters corresponding to a camera view location being programmed.

### CROSS-REFERENCE TO RELATED APPLICATION

This application is related to and claims priority to U.S. Provisional Patent Application Serial No. 60/280,875, filed Apr. 02, 2001, entitled VIDEO SYSTEM AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to video display characters, and in particular, to a method and system for generating manageable sized working lists of characters for data input using limited security system keyboard layouts.

### BACKGROUND OF THE INVENTION

With the increase in demand for compact video security systems comes the need for reduced size dedicated hardware. As such, much of the equipment sold into the video security market is based on dedicated hardware, rather than on PC platforms. Many dedicated hardware systems are supplied with keyboards that are often very small, with limited numbers of keys, oftentimes being without appropriate alphanumeric keys for inputting data. In systems where text must be entered into the system for labels and menus, the absence of alphanumeric keys forces the user to sequence through a list of all possible characters to find each entry. As such, the setup and data entry process becomes very laborious. For example, when a selected camera shows a video image of an cast hallway, it would be desirable for the user to label such a view as “east hallway 1”. However, the task of selecting the individual letters to spell out the label “east hallway 1” becomes a tedious task at best, consisting of scrolling through all available characters and selecting at least fourteen characters. In foreign language systems, such as Chinese, the huge number of possible characters makes this type of entry process virtually impossible.

### SUMMARY OF THE INVENTION

According to one aspect, the present invention provides a video apparatus which has a memory storing at least one main list of characters. An input device for selecting characters from the main list is provided. The selected characters are stored as at least one working list in the memory. A central processing unit is electrically coupled to the memory and the input device. The central processing unit executing a software program which activates a selected working list, displays the selected working list on a display monitor and stores the selected characters in the memory corresponding to a camera view location being programmed.

According to another aspect, the present invention provides a video system which has a first device with a first memory which stores at least one main list of characters and a first input device for selecting characters from the main list. The selected characters are stored in at least one working list in the first memory. A first central processing unit is electrically coupled to the first memory and the first input device. The first central processing unit executes a first software program which receives selections of specific characters from the first input device and stores the selected characters in the first memory as the working list. A second device is electrically coupled to the first device and is configured to receive the working list. The second device has a second memory for storing at least one working list of characters and a second input device for selecting characters from the working list. A second central processing unit is electrically coupled to the second memory and the second input device. The second central processing unit executing a second software program which activates a selected working list and stores characters selected from the working list in the second memory corresponding to the programmed camera view location.

According to still another aspect, the present invention provides a method of controlling a video system which creates a working list of characters from a main list of all possible characters, selects a character from the working list, assigns the character to a camera location view to be programmed and stores the assigned character for later recall.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary system constructed in accordance with the principles of the invention;

FIG. 2 is a block diagram of a central control unit constructed in accordance with the principles of the present invention;

FIG. 3 is a view of an exemplary working list selection screenshot;

FIG. 4 is a view of an exemplary screenshot of selected working list in use;

FIG. 5 is a flowchart describing a subset selection process; and

FIG. 6 is a flowchart describing a central control unit menu selection process.

### DETAILED DESCRIPTION OF THE INVENTION

To solve the problems presented by prior art systems and methods, the present invention provides a smaller working list that only contains the characters needed for a specific application. A main list contains all possible characters, and a working list, which is a subset of the main list, contains only those characters or words needed for the application. In this way, the user can step through and select needed characters much faster, as inapplicable characters have already been excluded from the working list. The user can edit the main list to make the working list. Additionally, many different working lists for specific applications can be created and accessed by the user.

The present invention provides a method and system for selecting individual characters to make up desired words describing views on cameras or specific menu selections. Alternatively, the characters can be pre-arranged into words such that individual word selection can be provided based on the working list generated from the universe of all possible words. Such a system can be implemented in any suitable foreign language. For example, individual word selection for labeling and menu creation is not only advantageous in the English language, such as for example selecting a specific “doorway 1 ” or “hallway 1”, but is also exceedingly useful when applied to Asian character sets, such as Chinese. Many of the Chinese ideograms used for such a system are symbols which represent individual words. As such, it is desirable to create a smaller working list of available words from the universe of possible words when a user is presented with the task of labeling or creating menus regarding a specific camera view or setup.

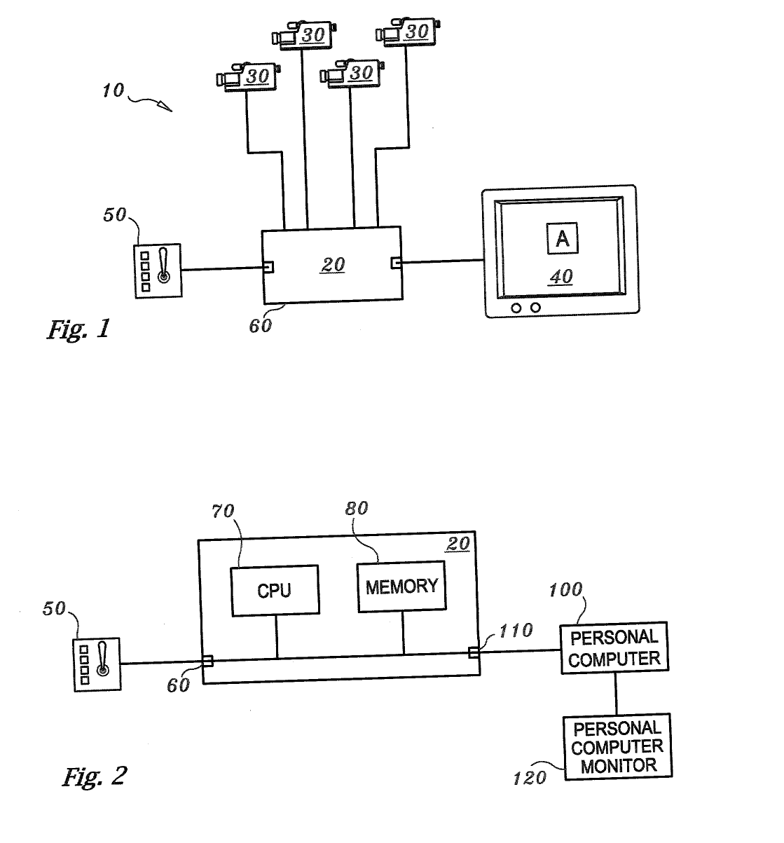

Referring now to the drawing figures in which like reference numerals refer to like elements, there is shown in FIG. 1 a system 10 constructed in accordance with the principles of the present invention. This system 10 preferably includes a central control unit 20 in communication with one or more video cameras 30, one or more video monitors 40, and one or more operator remote controllers 50 connected via a data interface 60. The central control unit 20 is configured to receive a video image signal from camera 30 and thereby route it to video monitor 40. Further, the functionality of central control unit 20 can be controlled by an operator via operator remote controller 50. For example, operator remote controller 50 can be used to select any one or more of the individual cameras 30 to display the video image signal originating from any such camera on monitor 40. Operator remote controller 50 can also be used to program automatic camera sequences of views from the individual cameras 30 as is known in the art.

It will be readily understood that when an operator is provided with multiple views from multiple cameras 30 and multiple alternate camera sequences, the many views and sequences can appear confusingly similar. For example, individual hallways and doorways in a large structure or building may confusingly appear to an operator to be the same image. Further, as many video security devices are able to accept programming of camera sequences which sequentially display images from different cameras for a predetermined period of time, operators are required to view multiple such sequences. Faced with numerous camera sequences, it is desirable to be able to label each individual sequence for later recall and identification. As such, it is desirable to provide labels and menus for either identifying or selecting different views and sequences from individual cameras 30. To individually label different views an operator must input a label associated with each individual camera view displayed on monitor 40.

It has been advantageously discovered that by reducing the number of available characters or words available for selection, the overall time for label creation can be greatly reduced. For example, when a system is set up using an alternate language, such as Chinese, it becomes advantageous to only supply the word characters or ideograms which are relevant to a particular installation site for the security system. Accordingly, if a system is installed in a hospital, then available characters may include the characters which stand for “ward”, “operating room”, “emergency room”, “elevator”, “administration” and so on. Accordingly, with respect to foreign languages such as Chinese, the list of possible ideographic characters which are in the Chinese language are reduced from several hundred to only relevant “labels” or characters, such as for example 50 characters. It will be readily understood that such a scheme can be implemented in other languages to great advantage, and need not be used only with characters but can be used with words as well. For example, the same scheme can be applied in English where a user scrolls through available words as opposed to characters, the stored words being words which are relevant to a specific installation site.

Operation of the present invention is discussed with reference to the security system shown in FIG. 1. By the method of the current invention the user need only select three individual words, namely “east”, “hallway”, and “1”, thus advantageously streamlining the selection process as compared with scrolling through and selecting each individual character. It is readily understood that the problems presented are increased by orders of magnitude when a language which has hundreds of characters is used. Thus, the present invention provides an advantageous system and method for efficiently inputting labels and menu items when faced with large selections of possible characters.

FIG. 2 is a block diagram showing an exemplary central control unit 20 having a central processing unit (CPU) 70, a memory storage unit 80 and a computer interface 90. The remote controller 50 is connected to the data input 60. Further shown is a personal computer 100 removably connected to the computer interface 90 via an interface link 110. Personal computer 100 also includes a computer display monitor 120, electrically connected thereto. It will be readily understood by one skilled in the art that the size and type of CPU can be selected based on the size and requirements of the system. An exemplary CPU can be a micro-controller or the type found in a mainframe computer, personal computer or other such device. An exemplary memory storage unit 80 is a random access memory (RAM) that stores data in digital form. Alternative examples of a memory storage unit 80 are electrically erasable programmable read only memory (EEPROM), flash memory, magnetic hard drive, optical hard drive and other such storage devices as are known in the art. The personal computer 100 also includes at least a central processing unit and a memory device (not shown).

The present invention also allows an operator to select a working list title from a pre-selected menu when performing a system set up procedure. The working list preferable comprises categories which represent pre-selected working lists. For example, when a user is setting up a system, he has the option of viewing the working list categories which have been predetermined. If the user determines that one of the categories is applicable to his installation site, he can select that title from which to set up the system.

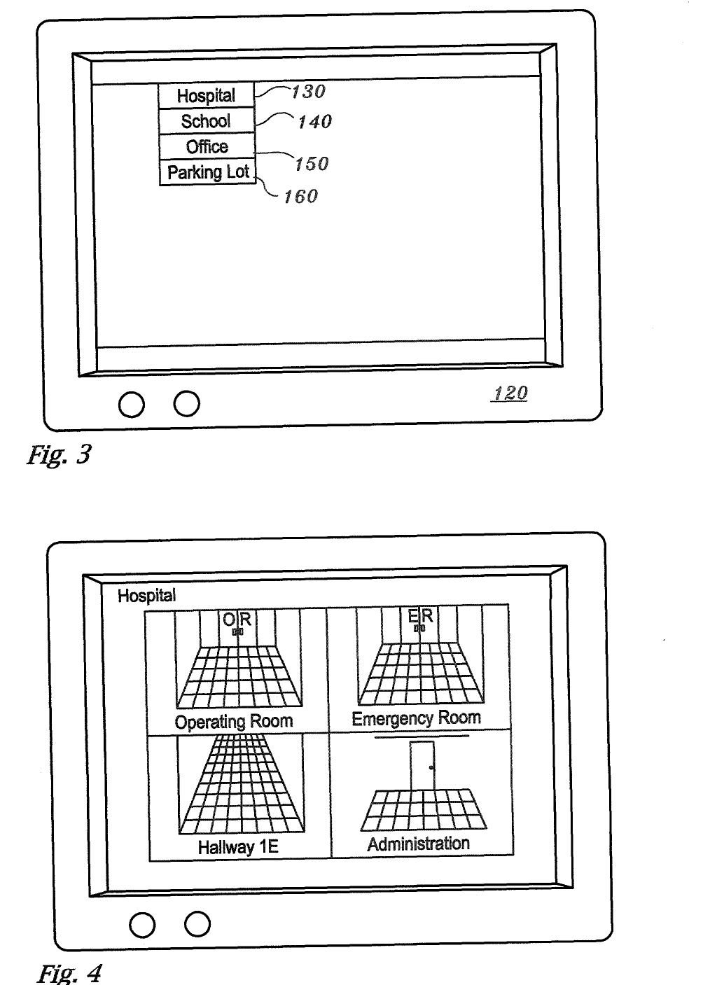

FIG. 3 shows an exemplary computer display monitor 120. Computer display monitor 120 is shown displaying an exemplary menu from which a user can select working list categories. Exemplary working list categories shown in FIG. 3 include a Hospital 130, School 140, Office 150 and Parking Lot 160. As an example, by selecting the working list title for “hospital” the user is provided with a list of commonly used words for labeling areas in a hospital. For example, the Hospital working list would contain the words, “ward”, “operating room”, “emergency room”, “elevator”, “administration” etc. The user would then have the option of using the working list as is, or to modify the working list by adding or subtracting words by the processes described herein.

FIG. 4 shows an exemplary computer display monitor 120 displaying a four camera split screen display. The system has been set up using a hospital working list and the presently displayed views have been labeled with words from the working list. Shown are the Operating Room, Emergency Room, Hallway 1E and the Administration Area. In will be readily understood that alternatively, individual views can be shown on the computer display monitor 120, one at a time. The four camera view display example shown in FIG. 4 is merely exemplary and is not meant to be limiting.

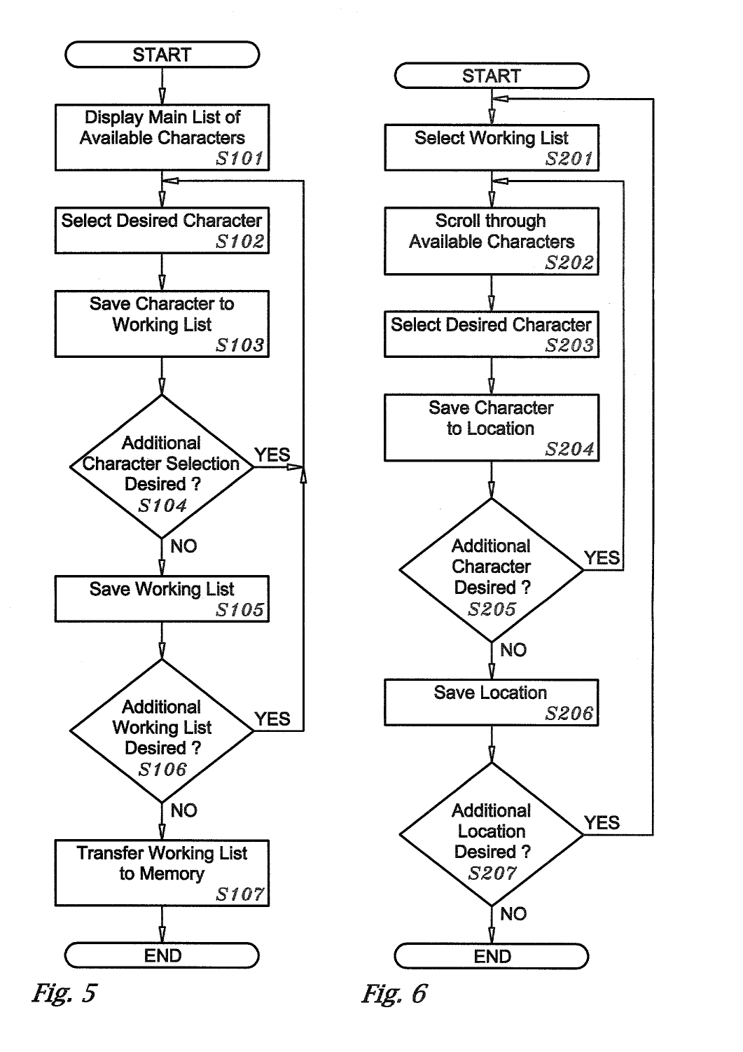

FIG. 5 is a flowchart of the subset selection process for creating a reduced subset or working list of available characters or words in accordance with the present invention. The process of selecting the working list can either be performed using the central control unit 20 or can be performed with a separate processing unit. For example, the creation of the working list can be performed on the personal computer 100 and then uploaded to the memory storage unit 80 in the central control unit 20 upon completion. When the creation of the working list begins, a full list of available characters is displayed or made available to the user on the computer display monitor 120 (Step S101). The user uses an input device on the personal computer 100 to select an individual character or word to be added to the working list (Step S102). Once the character has been selected, it is saved to the present working list temporarily in personal computer 100 (Step S103). Of course, the individual selection can be transmitted to memory 80 and stored there. In other words, the working list can be temporarily stored in personal computer 100 and transferred to memory 80 in bulk, or can be sequentially transferred to memory 80 with each individual selection.

The working list creation program then awaits further character selection. If an additional character is selected by the user the process returns to Step S102 (Step S104). However, if no additional character is selected within a pre-determined time period or the user indicates selection completion, the process continues to the next step (Step S104). After all the desired characters are selected the created working list is stored in the personal computer 100 memory or in memory 80 as noted above. (Step S105).

The subset selection program then determines whether an additional working list is to be created, if such a list is to be created the process returns to Step S102. However, if no additional working list is to be created, the process continues to the next step (Step S106). Upon completion of creation of the individual working list or working lists they are uploaded to the memory 80 via the interface link 100. In the alternative, the preceding steps can all be performed within the central control unit 20 (Step S107). In this case, the main list is displayed to the user on the monitor 40 and the character selection is performed using the remote control 50.

FIG. 6 is a flowchart of the central control unit 20 functions during label or menu selection. When a user activates the label or menu selection routine of the central control unit 20 to label a selected location, the following steps are performed. The user is prompted to select the desired working list from an available selection (Step S201). When the central processing unit 20 is instructed via the remote controller 50 to active the selection routine, the CPU 70 reads the appropriate data representing the available characters from the memory 80 and displays the working list on monitor 40. The user then uses the remote controller 50 to scroll or move through the available characters in the selected working list (Step S202). The user then selects the desired character with the remote controller 50 (Step S203). The CPU 70 temporarily saves the selected character either in its onboard memory or in memory 80 (Step S204).

The central control unit 20 then determines whether an additional character selection is desired. The central control unit 20 can either wait for additional selections for a predetermined time period, or can react based on the user's indication that either another character is to be selected or that selection is completed. If further character selection is desired, the process returns to Step S202 (Step S205). However, if no additional character selection is desired, the process continues to the next step (Step S205). Once all of the character selection for a given location is completed, that entry is saved by the central control unit 20 (Step S206). The CPU 70 saves the entire character selection to a location to memory 80 which corresponds to the label for the location being programmed. The central processing unit 20 then determines whether an additional location is to be programmed. The central processing unit 20 can either wait a predetermined time period for further selection, prompt the user with a visual query as to progression of further selection or wait for the user to end the routine. If an additional location is desired, the process returns to Step S201 (Step S207). However, if no additional location is to be programmed, the process moves to completion.

The present invention advantageously provides a method of reducing the large numbers of available characters and words that a user is presented with from which labeling and menuing is to be performed from. It has been advantageously discovered that by reducing the number of available characters or words available for selection, the overall time for label creation can be greatly reduced.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A video apparatus comprising:
a memory storing at least one main list of characters;
an input device for selecting characters from the main list, the selected characters being stored as at least one working list in the memory;
a central processing unit electrically coupled to the memory and the input device, the central processing unit executing a software program which performs functions including:
activating a selected working list;
displaying the selected working list on a display monitor; and
storing selected characters in the memory corresponding to a camera view location being programmed.

2. The video apparatus of claim 1, wherein the input device is an abbreviated keyboard.

3. The video apparatus of claim 1, wherein the input device is a joystick.

4. The video apparatus of claim 1, wherein the characters are alphanumeric characters.

5. The video apparatus of claim 1, wherein the characters are ideographic characters which represent words.

6. The video apparatus of claim 1, wherein the characters are words.

7. The video apparatus of claim 1, wherein the selected characters are stored in the memory individually as selected.

8. The video apparatus of claim 1, wherein the selected characters are stored in the memory as a group of characters once the selection process is completed.

9. A video system comprising:
a first device comprising:
a first memory storing at least one main list of characters;
a first input device for selecting characters from the main list, the selected characters being stored in at least one working list in the first memory;
a first central processing unit electrically coupled to the first memory and the first input device, the first central processing unit executing a first software program which performs functions including:
receiving selections of specific characters from the first input device; and
storing the selected characters in the first memory as the working list;
a second device electrically coupled to the first device operable to receive the working list and being operable to program a camera view location, the second device comprising:
a second memory for storing at least one working list of characters;
a second input device for selecting characters from the working list;
a second central processing unit electrically coupled to the second memory and the second input device, the second central processing unit executing a second software program which performs functions including:
activating a selected working list; and
storing characters selected from the working list in the second memory corresponding to the programmed camera view location.

10. The video system of claim 9, wherein the first device is a personal computer.

11. The video system of claim 9, wherein the second device is a central control unit.

12. The video system of claim 9, wherein the working list is transmitted from the first device to the second device via a computer interface.

13. The video system of claim 9, wherein the characters are alphanumeric characters.

14. The video system of claim 9, wherein the characters are ideographic characters.

15. The video system of claim 14, wherein the ideographic characters are Chinese characters.

16. The video system of claim 9, wherein the characters are words.

17. The video system of claim 9, wherein the second input device is an abbreviated keyboard.

18. The video system of claim 9, wherein the second input device is a joystick.

19. A method of controlling a video system comprising:
creating a working list of characters from a main list of all possible characters;
selecting a character from the working list;
assigning the character to a camera location view to be programmed; and
storing the assigned character for later recall.

20. The method of controlling a video system of claim 19, wherein creating the working list comprises:
displaying the main list;
selecting the character; and
saving the character corresponding to the working list.

21. The method of controlling a video system of claim 19, wherein the creating the working list is performed by a central control unit.

22. The method of controlling a video system of claim 19, wherein creating the reduced size working list is performed by a personal computer.

23. The method of controlling a video system of claim 22, further comprising transferring the working list to a central control unit.
